(19) United States
(12) Patent Application Publication
(10) Pub. No.: US 2021/0099712 A1
(43) Pub. Date: Apr. 1, 2021

(54) METHOD AND APPARATUS FOR DETERMINING COMPLEXITY OF A VIDEO FRAME

(71) Applicant: WANGSU SCIENCE & TECHNOLOGY CO., LTD., Shanghai (CN)

(72) Inventors: Xuehui HUANG, Shanghai (CN); Shibiao LV, Shanghai (CN)

(21) Appl. No.: 16/465,783

(22) PCT Filed: Sep. 28, 2018
(86) PCT No.: PCT/CN2018/108241

§ 371 Date: May 31, 2019

(30) Foreign Application Priority Data
Aug. 31, 2018 (CN) 201811011680.1

(51) Int. Cl. H04N 19/14; H04N 19/119; H04N 19/159; H04N 19/625; H04N 19/176

(52) U.S. Cl. CPC H04N 19/14; H04N 19/119; H04N 19/176; H04N 19/625; H04N 19/159

(57) ABSTRACT

The present invention discloses a method and an apparatus for determining complexity of a video frame. The method includes: obtaining a current video frame to be processed, dividing the current video frame into a specified number of picture blocks, and calculating an interframe prediction value and an intraframe prediction value of a picture block; determining time complexity of the picture block based on a difference between the interframe prediction value of the picture block and an original pixel value of the picture block and determining space complexity of the picture block based on a difference between the intraframe prediction value of the picture block and the original pixel value of the picture block; taking the smaller of the time complexity and the space complexity as a complexity of the picture block and determining a complexity of the current video frame based on the complexity of each of specified number of the picture blocks. The technical solution provided by the present application improves the precision of determining the complexity.

### FIELD OF THE DISCLOSURE

The present invention relates to the field of Internet technologies and, more particularly, relates to a method and an apparatus for determining complexity of a video frame.

### BACKGROUND

As the Internet technologies continue to advance, a substantial number of webcast platforms have emerged. A webcast platform brings a real-time video experience to a user and at the same time raises the requirement for user's network bandwidth. Currently, the webcast platform often limits a bit rate of a live video stream, such that the limited bit rate may adapt to the bandwidth provided by the user's network and may provide a smooth video experience to the user.

Currently, a setting of the bit rate of the live video stream may depend on an analysis of a picture complexity of the live video stream. However, existing methods of complexity analysis do not provide a sufficient precision.

### BRIEF SUMMARY OF THE DISCLOSURE

The objective of the present application is to provide a method and an apparatus for determining complexity of a video frame to improve the precision of complexity determination.

To achieve the above objective, the present application provides a method for determining complexity of a video frame. The method includes: obtaining a current video frame to be processed, dividing the current video frame into a specified number of picture blocks, and calculating an interframe prediction value and an intraframe prediction value of a picture block; determining time complexity of the picture block based on a difference between the interframe prediction value of the picture block and an original pixel value of the picture block and determining space complexity of the picture block based on a difference between the intraframe prediction value of the picture block and the original pixel value of the picture block; and taking the smaller of the time complexity and the space complexity as a complexity of the picture block and determining a complexity of the current video frame based on the complexity of each of specified number of the picture blocks.

To achieve the above objective, the present application provides an apparatus for determining complexity of a video frame. The apparatus includes: a prediction value calculation unit configured to obtain a current video frame to be processed and to calculate an interframe prediction value and an intraframe prediction value of a picture block after the current video frame is divided into a specified number of picture blocks; a time-space complexity determination unit configured to determine time complexity of the picture block based on a difference between the interframe prediction value of the picture block and an original pixel value of the picture block and space complexity of the picture block based on a difference between the intraframe prediction value of the picture block and the original pixel value of the picture block; and a complexity determination unit configured to take the smaller of the time complexity and the space complexity as the complexity of the picture block and to determine the complexity of the current video frame based on the complexity of each of the specified number of the picture blocks.

To achieve the above objective, the present application provides an apparatus for determining complexity of a video frame. The apparatus includes: a memory for storing a computer program; and a processor for executing the computer program stored in the memory to implement the disclosed method.

It can be seen from the above that, when determining the complexity of the video frame, the technical solution provided by the present application may first divide the current video frame into a specified number of picture blocks to reduce an amount of data to be processed each time. For each picture block, an interframe prediction value and an intraframe value of the picture block may be calculated respectively. Based on the calculated interframe prediction value and the intraframe prediction value, time complexity and space complexity of the picture block may be determined respectively. The time complexity may reflect a degree of picture change between the current video frame and the immediately preceding video frame while the space complexity may reflect a degree of complexity of texture details in the current video frame. Then, the smaller of the time complexity and the space complexity may become the complexity of the picture block. Because the current video frame is composed of the specified number of the picture blocks, after the complexity of each picture block is determined, an overall complexity of the current video frame may eventually be determined based on the complexity of each of the specified number of the picture blocks. It can be seen from the above that the technical solution provided by the present application may divide the current video frame into multiple picture blocks to ensure that the amount of the data processed each time is not too large. The technical solution may improve the efficiency of data processing, at the same time avoid calculation errors caused by excessively large amount of data to be processed each time, and hence improve a calculation precision of the overall complexity. In addition, determining the complexity of the current video frame based on tow dimensions of the time complexity and the space complexity may be applicable to various types of video frames, thereby further improving the calculation precision of the overall complexity.

### BRIEF DESCRIPTION OF THE DRAWINGS

In order to more clearly illustrate the technical solutions in the embodiments of the present invention, drawings used in the description of the embodiments will be briefly described below. Obviously, the drawings in the following description are only some embodiments of the present invention. Other drawings may also be obtained by those of ordinary skill in the art without inventive work.

FIG. 1 illustrates a flow chart of an exemplary method for determining complexity of a video frame according to disclosed embodiments;

FIG. 2 illustrates a block diagram of an exemplary apparatus for determining complexity of a video frame according to disclosed embodiments; and

FIG. 3 illustrates a schematic diagram of an exemplary apparatus for determining complexity of a video frame according to disclosed embodiments.

### DETAILED DESCRIPTION

To make the objectives, technical solutions, and advantages of the present invention clearer, the following further describes the embodiments of the present invention in details with reference to the accompanying drawings.

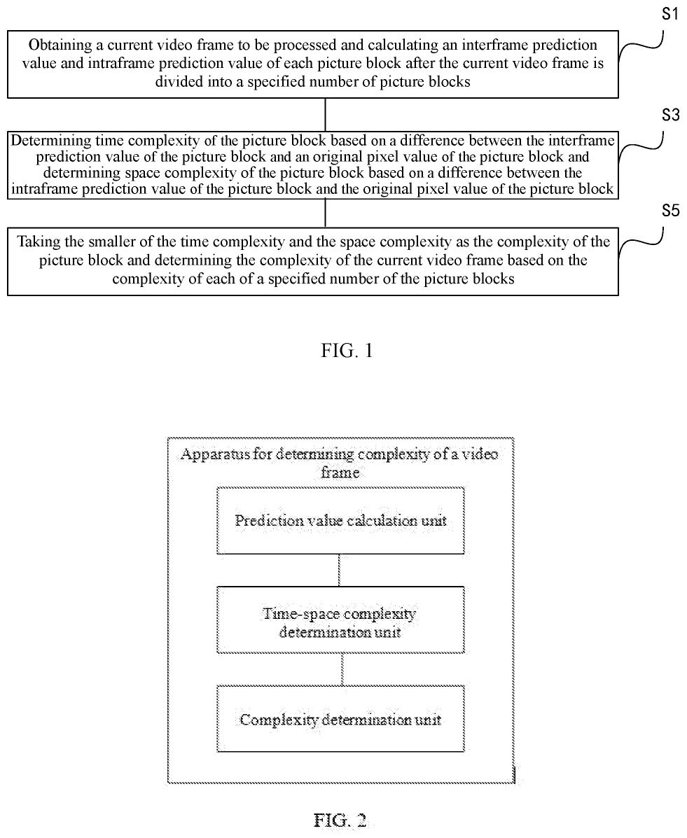

The present application provides a method for determining complexity of a video frame. Referring to FIG. 1, the method may include the following steps.

Step S1: obtaining a current video frame to be processed and calculating an interframe prediction value and intraframe prediction value of each picture block after the current video frame is divided into a specified number of picture blocks.

In one embodiment, when analyzing complexity of the current video frame, to reduce an amount of data processed each time, the current video frame may be divided into the specified number of the picture blocks. The divided picture blocks may have an equal size. In addition, the size of the divided picture blocks may be determined according to a video coding format corresponding to the current video frame. Specifically, the size of the divided picture blocks may be the same as a size of a maximum coding unit of the video coding format. For example, assuming the video coding format corresponding to the current video frame is a H.264 coding format, the size of the divided picture blocks may be 16*16. In another example, assuming the video coding format corresponding to the current video frame is a H.265 coding format, the size of the divided picture blocks may be 64*64. The size of the picture blocks may be defined in pixels. The picture block of 16*16 may include 16 pixels in both a horizontal direction and a vertical direction.

In one embodiment, considering that an actual resolution of the current video frame may be large or small, if the picture blocks are divided purely according to the coding format, the size of the divided picture blocks may not be appropriate. For example, if the resolution of the current video frame is small, the size of the picture blocks divided according to the above method may appear too large. In another example, if the resolution of the current video frame is large, the size of the picture blocks divided according to the above method may appear too small. Thus, in practical applications, after the size of the picture blocks are determined according to the video coding format, the size of the picture blocks may be adjusted according to the actual resolution of the current video frame. For example, if the size of the divided picture blocks are too large, the size of the picture blocks may be appropriately reduced to yield more divided picture blocks. On the contrary, if the size of the divided picture blocks are too small, the size of the picture blocks may be appropriately increased to yield less divided picture blocks.

In one embodiment, after the current video frame having a substantially large resolution is divided into a plurality of picture blocks, the amount of data to be processed for each picture block may still be substantially large. In this case, the current video frame may be down sampled in advance to reduce the resolution of the current video frame, thereby reducing the amount of data to be processed subsequently. Specifically, after the current video frame to be processed is obtained, the resolution of the current video frame may be recognized. If the resolution is greater than or equal to a specified resolution threshold, it indicates that the resolution of the current video frame is too large. At this point, the current video frame may be down sampled to obtain a down-sampled video frame. For example, the current video frame may have a resolution 1280*720. The current video frame may be down sampled to have a resolution 640*360. For the original current video frame, the size of the corresponding picture blocks may be determined according to the video coding format. For example, the current video frame in the resolution 1280*720 may correspond to a 16*16 size of the picture blocks. After the current video frame is down sampled, the corresponding size of the picture blocks may be reduced. Specifically, the resolution of the down-sampled video frame may be divided by the resolution of the original video frame to obtain a down-sampling coefficient. Then, the down-sampling coefficient may be used to convert the original size of the picture blocks to obtain the size of the picture blocks corresponding to the down-sampled video frame. For example, after the current video frame having the resolution 1280*720 is down sampled to have the resolution 640*360, the size of the corresponding picture blocks may be reduced from the 16*16 to 8*8. In one embodiment, after the original current video frame is down sampled to obtain the down-sampled video frame, the complexity of the down-sampled video frame may be used as the complexity of the current video frame.

In one embodiment, when determining the complexity of the current video frame or the down-sampled video frame, complexities of each of the divided picture blocks may be calculated in advance. Then, the complexities of each of the divided picture blocks may be added to obtain the overall complexity of the current video frame. Specifically, when calculating the complexity of each picture block, it is preferred to calculate an interframe prediction value and an intraframe prediction value of each picture block.

In one embodiment, when calculating the interframe prediction value of the picture block, coordinates of a designated vertex of the picture block may be obtained, and a width and a height for characterizing a motion search range may be determined. For example, the designated vertex may be an upper left corner of the picture block. The coordinates of the designated vertex may be denoted by (y,x), where x is a horizontal coordinate of the designated vertex and y is a vertical coordinate of the designated vertex. The motion search may refer to a process of searching a picture block in a preceding video frame similar to the picture block in the current video frame. In practical applications, the motion search may often be confined to a range defined by the width and height of the motion search range described previously.

In one embodiment, the coordinates of the designated vertex and the width and height of the motion search range may be used to determined multiple sets of search parameters. Each set of search parameters may include the horizontal and vertical coordinates. Specifically, in one practical example, the following formulas may be used to determine the multiple sets of the search parameters:

|y−y₀|≤SH; and

|x−x₀|≤SW,

where x is a horizontal coordinate of the designated vertex, y is a vertical coordinate of the designated vertex, y₀ is a vertical coordinate of a search parameter, SH is a height of the motion search range, x₀ is a horizontal coordinate of a search parameter, and SW is a width of the motion search range. Coordinates (y₀,x₀) that satisfy the above condition constitute a set of search parameters.

In one embodiment, a search result may be calculated for each set of search parameters, respectively. A search value corresponding to a minimum search result may be an adapted search value. Specifically, in one example, the following formula may be used to determine the adapted search value:

$${argmin}_{{y}_{0} , {x}_{0}} {\sum }_{s = 0}^{bh - 1} {\sum }_{t = 0}^{bw - 1} \vert {P}_{p} ( y + s , x + t ) - {P}_{p - 1} ( s + {y}_{0} , t + {x}_{0} ) \vert ,$$

where bh is a height of the picture block, bw is a width of the picture block, s is an integer from 0 to bh−1, t is an integer from 0 to bw−1, Pₚ (y+s,x+t) is a pixel value of a pixel at coordinates (y+s,x+t) in the current video frame, and Pₚ₋₁(s+y₀,t+x₀) is a pixel value of a pixel at coordinates (s+y₀,t+x₀) in the video frame immediately preceding the current video frame.

As such, a final adapted search value may be obtained by substituting different search values into the above formula.

In one embodiment, after the adapted search value is determined, the interframe prediction value of the picture block may be determined based on the pixel value of the pixel in the video frame immediately preceding the current video frame and the adapted search value. Specifically, in one example, the following formula may be used to determine the interframe prediction value of the picture block:

Bᵢₙₜₑᵣ(i,j)=Pₚ₋₁(i+y₀,j+x₀),

where Bᵢₙₜₑᵣ(i,j) is the interframe prediction value corresponding to the pixel at coordinates (i,j) in the picture block, Pₚ₋₁(i+y₀,j+x₀) is the pixel value of the pixel at coordinates (i+y₀,j+x₀) in the video frame immediately preceding the current video frame, i is an integer from 0 to bh−1, and j is an integer from 0 to bw−1.

As such, the determined interframe prediction value may be a matrix. Each element in the matrix may correspond to each pixel in the picture block.

In one embodiment, when calculating the intraframe prediction value of the picture block, a current intraframe prediction method may be used to determine candidate prediction values in a plurality of specified directions. Specifically, the current intraframe prediction method may be implemented in an intraframe prediction mode in an encoding process of coding formats such as H.264, H.265, or VP9, etc. The existing intraframe prediction mode may produce different candidate prediction values for different prediction directions. In one embodiment, only the horizontal direction, the 45° angular direction, the vertical direction, and the 135° angular direction may be selected as the specified directions to calculate the candidate prediction values. A corresponding evaluation value may be calculated for the candidate prediction value in each specified direction, respectively. In one example, the following formula may be used to calculate the evaluation value corresponding to a candidate prediction value in a target specified direction among the candidate prediction values in the plurality of specified directions:

SAD=Σₛ₌₀^{bh-1}Σₜ₌₀^{bw-1}|Pₚ(y+s,x+t)−Cᵢₙₜᵣₐ(s,t)|,

where SAD is the evaluation value corresponding to the candidate prediction value in the target specified direction, bh is the height of the picture block, bw is the width of the picture block, s is an integer from 0 to bh−1, t is an integer from 0 to bw−1, Cᵢₙₜᵣₐ(s,t) is the candidate prediction value of the pixel at coordinates (s,t) in the target specified direction, and Pₚ(y+s,x+t) is the pixel value of the pixel at coordinates (y+s,x+t) in the current video frame.

In one embodiment, the above formula may be used to calculate the evaluation value corresponding to the candidate prediction value in each specified direction. Then, the candidate prediction value corresponding to a minimum evaluation value may become the intraframe prediction value of the picture block.

Step S3: determining time complexity of the picture block based on a difference between the interframe prediction value of the picture block and an original pixel value of the picture block and determining space complexity of the picture block based on a difference between the intraframe prediction value of the picture block and the original pixel value of the picture block.

In one embodiment, after the interframe prediction value and the intraframe prediction value of the picture block are calculated, the corresponding time complexity and space complexity may be calculated. The time complexity may reflect a degree of picture change between the current video frame and the immediately preceding video frame while the space complexity may reflect a degree of complexity of texture details in the current video frame.

In one embodiment, the time complexity of the picture block may be determined based on the difference between the interframe prediction value of the picture block and the original pixel value of the picture block. Specifically, the interframe prediction value of the picture block may be a matrix. Each element of the matrix may one-to-one correspond to each pixel in the picture block. Thus, when calculating the difference between the interframe prediction value of the picture block and the original pixel value of the picture block, an element of the interframe prediction value may be subtracted from a corresponding element of the pixel value at the same position to obtain a difference at the position. As such, the obtained difference may also be a matrix. In one embodiment, after the difference in the form of the matrix is calculated, a discrete cosine transformation may be performed on the difference. A sum of the absolute values of coefficients after the discrete cosine transformation may become the time complexity of the picture block.

Similarly, when calculating the space complexity, the discrete cosine transformation may be performed on the difference between the interframe prediction value of the picture block and the original pixel value of the picture block. A sum of the absolute values of coefficients after the discrete cosine transformation may become the space complexity of the picture block.

Step S5: taking the smaller of the time complexity and the space complexity as the complexity of the picture block and determining the complexity of the current video frame based on the complexity of each of a specified number of the picture blocks.

In one embodiment, after the time complexity and the space complexity of the picture block is obtained, the smaller of the time complexity and the space complexity may become the complexity of the picture block. As such, because the current video frame is composed of the specified number of the picture blocks, the complexity of the current video frame may be determined based on the complexity of each of the specified number of the picture blocks. Specifically, the complexity of each of the picture blocks may be added together to obtain the complexity of the current video frame and to complete the process for determining the complexity of the current video frame. In one embodiment, the process for analyzing the complexity of the current video frame may be performed before the current video frame is encoded. Specifically, in practical applications, if no internal information of an encoder in the encoding process is used, a picture complexity of the current video frame may be first analyzed before the current video frame is inputted to the encoder for encoding. On the other hand, if the internal information of the encoder in the encoding process is used, the current vide frame may be inputted directly to the encoder. After the encoder recognizes a frame type of the current video frame, the picture complexity of the current video frame may be analyzed. The internal information may include the frame type of the current video frame recognized by the encoder. If no internal information is used, it indicates that the frame type of the current video frame is unknown when the picture complexity of the current video frame is analyzed. On the other hand, if the internal information is used, it indicates that the frame type of the current video frame is determined when the picture complexity of the current video frame is analyzed. The frame type of the current video frame may include a B-frame, an I-frame, and a P-frame. The I-frame may be referred to as an internal picture frame or a key frame. The I-frame may be an independent frame, independent of other adjacent video frames. The P-frame may be referred to as a forward search frame. The B-frame may be referred to as a bi-directional search frame. The P-frame and the B-frame may be dependent on the immediately preceding video frame or the two immediately adjacent video frames.

In one embodiment, if the frame type of the current video frame is unknown or is recognized not to be an internal picture frame (I-frame), it indicates that the current video frame is dependent on other video frames. At this point, the above formula may be required to calculate the interframe prediction value and the intraframe prediction value of the picture block and to determine the time complexity that reflects the degree of picture change between the current video frame and the immediately preceding video frame and the space complexity that reflects the degree of complexity of the texture details in the current video frame. On the other hand, if the current video frame is recognized to be an internal picture frame (I-frame), it indicates that the current video frame is independent on other video frames. Thus, it is not required to determine the time complexity. Only the intraframe prediction value of the picture block need to be calculated. The complexity of the picture block may include only the space complexity determined based on the difference between the intraframe prediction value of the picture block and the original pixel value of the picture block.

It can be seen from the above that the technical solution provided by the present application may precisely analyze the picture complexity regardless of the use of the internal information of the encoder in the encoding process, thereby independent of the internal information of the encoder.

Referring to FIG. 2, the present application also provides an apparatus for determining complexity of a video frame. The apparatus may include a prediction value calculation unit, a time-space complexity determination unit, and a complexity determination unit. The prediction value calculation unit may be configured to obtain a current video frame to be processed and to calculate an interframe prediction value and an intraframe prediction value of a picture block after the current video frame is divided into a specified number of picture blocks. The time-space complexity determination unit may be configured to determine time complexity of the picture block based on a difference between the interframe prediction value of the picture block and an original pixel value of the picture block and space complexity of the picture block based on a difference between the intraframe prediction value of the picture block and the original pixel value of the picture block. The complexity determination unit may be configured to take the smaller of the time complexity and the space complexity as the complexity of the picture block and to determine the complexity of the current video frame based on the complexity of each of the specified number of the picture blocks.

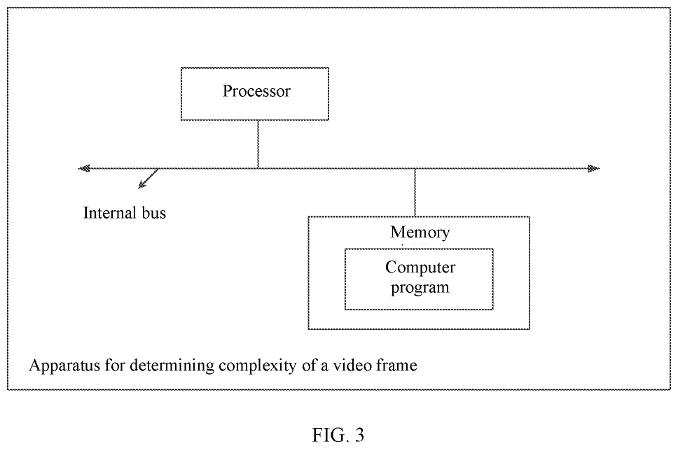

Referring to FIG. 3, the present application also provides another apparatus for determining complexity of a video frame. The apparatus may include a memory and a processor. The memory may be configured to store a computer program. When executed by the processor, the computer program may implement the disclosed method for determining complexity of a video frame.

It can be seen from the above that, when determining the complexity of the video frame, the technical solution provided by the present application may first divide the current video frame into a specified number of picture blocks to reduce an amount of data to be processed each time. For each picture block, an interframe prediction value and an intraframe value of the picture block may be calculated respectively. Based on the calculated interframe prediction value and the intraframe prediction value, time complexity and space complexity of the picture block may be determined respectively. The time complexity may reflect a degree of picture change between the current video frame and the immediately preceding video frame while the space complexity may reflect a degree of complexity of texture details in the current video frame. Then, the smaller of the time complexity and the space complexity may become the complexity of the picture block. Because the current video frame is composed of the specified number of the picture blocks, after the complexity of each picture block is determined, an overall complexity of the current video frame may eventually be determined based on the complexity of each of the specified number of the picture blocks. It can be seen from the above that the technical solution provided by the present application may divide the current video frame into multiple picture blocks to ensure that the amount of the data processed each time is not too large. The technical solution may improve the efficiency of data processing, at the same time avoid calculation errors caused by excessively large amount of data to be processed each time, and hence improve a calculation precision of the overall complexity. In addition, determining the complexity of the current video frame based on tow dimensions of the time complexity and the space complexity may be applicable to various types of video frames, thereby further improving the calculation precision of the overall complexity.

Through the description of the above embodiments, those skilled in the art may clearly understand that the embodiments may be implemented in software on a general-purpose hardware platform or implemented in hardware. Based on such understanding, the above described technical solution or the contribution beyond the existing technology may be embodied in the form of software product. The software product may be stored in a computer readable storage medium such as a ROM/RAM, a magnetic disk, or an optical disk, etc. The software product may include program instructions to be executed by a computer (e.g., a personal computer, a server, or a network device, etc.) to implement various method embodiments or portions of various method embodiments.

It should be understood by those skilled in the art that the foregoing are merely certain preferred embodiments of the present invention and are not intended to limit the present invention. Without departing from the spirit and principles of the present invention, any modifications, equivalent substitutions, and improvements, etc. shall fall within the scope of the present invention.

1. A method for determining complexity of a video frame, comprising:
obtaining a current video frame to be processed, dividing the current video frame into a specified number of picture blocks, and calculating an interframe prediction value and an intraframe prediction value of a picture block;
determining time complexity of the picture block based on a difference between the interframe prediction value of the picture block and an original pixel value of the picture block and determining space complexity of the picture block based on a difference between the intraframe prediction value of the picture block and the original pixel value of the picture block; and
taking the smaller of the time complexity and the space complexity as a complexity of the picture block and determining a complexity of the current video frame based on the complexity of each of specified number of the picture blocks.

2. The method of claim 1, wherein calculating the interframe prediction value of the picture block includes:
obtaining coordinates of a designated vertex of the picture block and determining a width and a height of a motion search range;
based on the coordinates of the designated vertex and the width and height of the motion search range, determining multiple sets of search parameters, wherein each set of search parameters includes horizontal and vertical coordinates;
calculating a corresponding search result for each set of search parameters respectively and taking a search value corresponding to a minimum search result as an adapted search value; and
based on the pixel value in the video frame immediately preceding the current video frame and the adapted search value, determining the interframe prediction value of the picture block.

3. The method of claim 2, wherein multiple sets of search parameters are determined based on the following formulas:

|y−y₀|≤SH; and

|x−x₀|≤SW,
wherein x is a horizontal coordinate of the designated vertex, y is a vertical coordinate of the designated vertex, y₀ is a vertical coordinate of a search parameter, SH is the height of the motion search range, x₀ is a horizontal coordinate of a search parameter, and SW is the width of the motion search range.

4. The method of claim 3, wherein an adapted search value is determined based on the following formula:
$${argmin}_{{y}_{0} , {x}_{0}} {\sum }_{s = 0}^{bh - 1} {\sum }_{t = 0}^{bw - 1} \vert {P}_{p} ( y + s , x + t ) - {P}_{p - 1} ( s + {y}_{0} , t + {x}_{0} ) \vert ,$$
wherein bh is a height of the picture block, bw is a width of the picture block, s is an integer from 0 to bh−1, t is an integer from 0 to bw−1, Pₚ(y+s,x+t) is a pixel value of a pixel at coordinates (y+s,x+t) in the current video frame, and Pₚ₋₁(s+y₀,t+x₀) is a pixel value of a pixel at coordinates (s+y₀,t+x₀) in the video frame immediately preceding the current video frame.

5. The method of claim 4, wherein the interframe prediction value of the picture block is determined based on the following formula:
Bᵢₙₜₑᵣ(i,j)=Pₚ₋₁(i+y₀,j+x₀),
wherein Bᵢₙₜₑᵣ(i,j) is the interframe prediction value corresponding to a pixel at coordinates (i,j) in the picture block, Pₚ₋₁(i+y₀,j+x₀) is the pixel value of a pixel at coordinates (i+y₀,j+x₀) in the video frame immediately preceding the current video frame, i is an integer from 0 to bh−1, and j is an integer from 0 to bw−1.

6. The method of claim 1, wherein calculating the intraframe prediction value of the picture block includes:
obtaining candidate prediction values of the picture block in a plurality of specified directions and calculating an evaluation value corresponding to the candidate prediction value in each specified direction; and
taking the candidate prediction value corresponding to a minimum evaluation value as the intraframe prediction value of the picture block.

7. The method of claim 6, wherein the evaluation value corresponding to a candidate prediction value in a target specified direction among the candidate prediction values in the plurality of specified directions is determined based on the following formula:
SAD=Σₛ₌₀^{bh-1}Σₜ₌₀^{bw-1}|Pₚ(y+s,x+t)−Cᵢₙₜᵣₐ(s,t)|,
wherein SAD is the evaluation value corresponding to the candidate prediction value in the target specified direction, bh is the height of the picture block, bw is the width of the picture block, s is an integer from 0 to bh−1, t is an integer from 0 to bw−1, Cᵢₙₜᵣₐ(s,t) is the candidate prediction value of a pixel at coordinates (s,t) in the target specified direction, and Pₚ(y+s,x+t) is the pixel value of a pixel at coordinates (y+s,x+t) in the current video frame.

8. The method of claim 1, wherein determining the time complexity and the space complexity of the picture block includes:
performing a discrete cosine transformation on the difference between the interframe prediction value of the picture block and the original pixel value of the picture block and taking a sum of the absolute values of coefficients after the discrete cosine transformation as the time complexity of the picture block; and
performing a discrete cosine transformation on the difference between the intraframe prediction value of the picture block and the original pixel value of the picture block and taking a sum of the absolute values of coefficients after the discrete cosine transformation as the space complexity of the picture block.

9. The method of claim 1, wherein determining the complexity of the current video frame includes:
adding the complexity of each of the picture blocks together to obtain the complexity of the current video frame.

10. The method of claim 1, after the current video frame is divided into the specified number of the picture blocks, the method further includes:
if a frame type of the current video frame is unknown or is recognized not to be an internal picture frame, calculating both the interframe prediction value and the intraframe prediction value of the picture block; and
if the frame type of the current video frame is recognized to be the internal picture frame, calculating only the intraframe prediction value of the picture block and taking the space complexity determined based on the difference between the intraframe prediction value of the picture block and the original pixel value of the picture block as the complexity of the picture block.

11. The method of claim 1, after the current video frame to be processed is obtained, the method further includes:
recognizing a resolution of the current video frame; and
down sampling the current video frame to obtain the down-sampled video frame if the resolution is greater than or equal to a specified resolution threshold, wherein the complexity of the down-sampled video frame becomes the complexity of the current video frame.

12. An apparatus for determining complexity of a video frame, comprising:
a prediction value calculation unit configured to obtain a current video frame to be processed and to calculate an interframe prediction value and an intraframe prediction value of a picture block after the current video frame is divided into a specified number of picture blocks;
a time-space complexity determination unit configured to determine time complexity of the picture block based on a difference between the interframe prediction value of the picture block and an original pixel value of the picture block and space complexity of the picture block based on a difference between the intraframe prediction value of the picture block and the original pixel value of the picture block; and
a complexity determination unit configured to take the smaller of the time complexity and the space complexity as the complexity of the picture block and to determine the complexity of the current video frame based on the complexity of each of the specified number of the picture blocks.

13. An apparatus for determining complexity of a video frame, comprising:
a memory for storing a computer program; and
a processor for executing the computer program stored in the memory to implement a method for determining complexity of the video frame, wherein the method includes:
obtaining a current video frame to be processed, dividing the current video frame into a specified number of picture blocks, and calculating an interframe prediction value and an intraframe prediction value of a picture block;
determining time complexity of the picture block based on a difference between the interframe prediction value of the picture block and an original pixel value of the picture block and determining space complexity of the picture block based on a difference between the intraframe prediction value of the picture block and the original pixel value of the picture block; and
taking the smaller of the time complexity and the space complexity as a complexity of the picture block and determining a complexity of the current video frame based on the complexity of each of specified number of the picture blocks.
